(19) United States
(12) Patent Application Publication
(10) Pub. No.: US 2024/0036449 A1
(43) Pub. Date: Feb. 1, 2024

(54) Light source module and projection device

(71) Applicant: Coretronic Corporation, Hsin-Chu (TW)

(72) Inventors: WEI-YI LEE, Hsin-Chu (TW); WEN-HAO CHU, Hsin-Chu (TW)

(21) Appl. No.: 18/226,796

(22) Filed: Jul. 27, 2023

(30) Foreign Application Priority Data
Jul. 29, 2022 (CN) 202210908517.5

(51) Int. Cl. G03B 21/16; G03B 21/20

(52) U.S. Cl. CPC G03B 21/16; G03B 21/2066

(57) ABSTRACT

A light source module applicable to a projection device includes a heat dissipation assembly, a first light source, and a second light source. The heat dissipation assembly includes first and second heat dissipation components. The first heat dissipation component includes a first base and a first fin set. The first fin set has a first ventilation surface. The second heat dissipation component includes a second base and a second fin set. The second base has a first surface, a second surface and a ventilation opening. The first surface is opposite to the second surface. The second fin set is arranged on the first surface. The second surface faces the first ventilation surface. The ventilation opening penetrates the first and second surfaces and is aligned with the first ventilation surface. The first light source is arranged on the first base. The second light source is arranged on the second base.

### CROSS-REFERENCE TO RELATED APPLICATION

This application claims the priority benefit of China application (No. 202210908517.5), filed on Jul. 29, 2022. The entirety of the above-mentioned patent application is hereby incorporated by reference herein and made a part of this specification.

### TECHNICAL FIELD

The disclosure relates to a light source module, and more particularly to a light source module applicable to a projection device and including a heat dissipation assembly, and a projection device including the light source module.

### BACKGROUND

With the market requirements for brightness, color saturation, service life, non-toxic environmental protection, etc of projection apparatus, the types of light sources used in the projection apparatus have evolved from UHP lamps, light emitting diode (LED) to laser diode (LD).

The light source may generate a lot of heat energy during operation, thus, a heat dissipation module and a fan are usually arranged in the projection device to dissipate heat from the light source. The conventional heat dissipation module includes a plurality of heat dissipation fin set and heat pipes respectively connected to the heat dissipation fin set to improve heat dissipation efficiency. In addition, some projection devices are equipped with a plurality of light sources with different emission wavelengths to improve image quality. However, limited by the optical path design in the projection device, the position of each light source cannot be easily changed, and the position of the heat dissipation fin set can only correspond to the respective light source. Therefore, the configuration of the heat dissipation fin set is quite limited in the projection device, which makes it difficult to significantly improve the overall heat dissipation efficiency of the projection device.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

The disclosure provides a light source module to improve heat dissipation efficiency.

The disclosure provides a projection device to improve image quality and durability.

Other advantages and objectives of the disclosure may be further illustrated by the technical features broadly embodied and described as follows.

In order to achieve one or a portion of or all of the objectives or other objectives, the light source module provided by the disclosure is applicable to a projection device and includes a heat dissipation assembly, a first light source, and a second light source. The heat dissipation assembly includes a first heat dissipation component and a second heat dissipation component. The first heat dissipation component includes a first base and a first fin set connected with each other. The first fin set has a first ventilation surface. The second heat dissipation component includes a second base and a second fin set. The second base has a first surface, a second surface, and a ventilation opening. The first surface is opposite to the second surface. The second fin set is arranged on the first surface. The second surface faces the first ventilation surface. The ventilation opening penetrates the first surface and the second surface and is aligned with the first ventilation surface. The first light source is arranged on the first base. The second light source is arranged on the second base.

In order to achieve one or a portion of or all of the objectives or other objectives, the projection device provided by the disclosure includes a housing, the aforementioned light source module, a light valve module, and a projection lens. The light source module, the light valve module, and the projection lens are arranged in the housing. The housing has a ventilation hole. The light source module is configured to provide an illumination beam. The light valve module is arranged on a transmission path of the illumination beam and configured to convert the illumination beam into an image beam. The projection lens is arranged on a transmission path of the image beam and configured to project the image beam.

In an embodiment of the disclosure, the aforementioned light source module may further include the third light source described above. The heat dissipation assembly further includes the third heat dissipation component.

In the light source module of the embodiment of the disclosure, the second heat dissipation component adopts a second base having a ventilation opening, and the ventilation opening is aligned with the first ventilation surface of the first fin set. Therefore, the airflow generated by the fan can still flow through the first heat dissipation component and the second heat dissipation component through the ventilation opening even when the first heat dissipation component and the second heat dissipation component cannot be configured in the same ventilation direction. Based on the above, the light source module of the disclosure can improve the heat dissipation efficiency without changing the existing conditions such as the optical path design and the fan flow field. By adopting the light source module, the projection device of the embodiment of the disclosure can have good image quality and durability.

Other objectives, features, and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a light source module of an embodiment of the disclosure;

FIG. 2 is a stereoscopic schematic view of the first heat dissipation component and the second heat dissipation component in FIG. 1;

FIG. 3 is a stereoscopic schematic view of the first heat dissipation component and the second heat dissipation component of the light source module of another embodiment of the disclosure;

FIG. 4 is a schematic view of the second heat dissipation component and the third heat dissipation component of the light source module in FIG. 1;

FIG. 5 is a schematic view of a light source module of another embodiment of the disclosure;

FIG. 6 is a schematic view of the third heat dissipation component and the second deflector in FIG. 5; and

FIG. 7 is a schematic view of a projection device of an embodiment of the disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

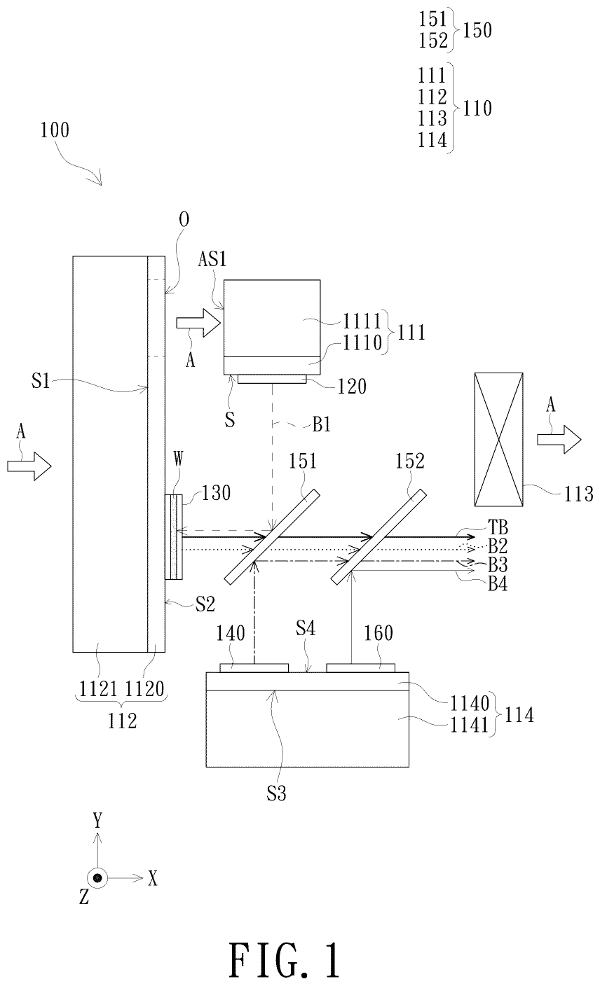

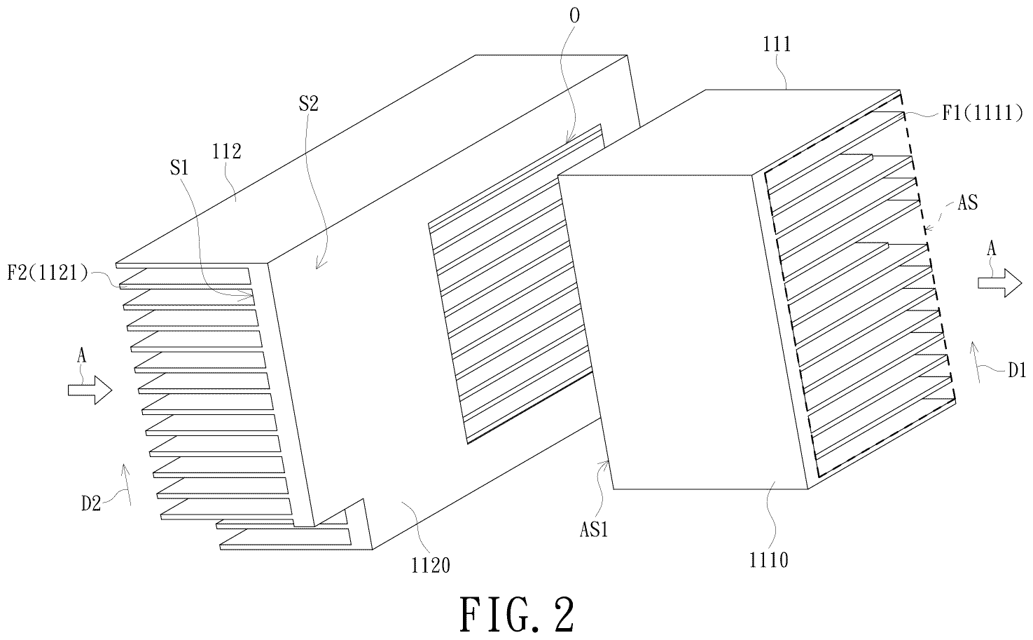

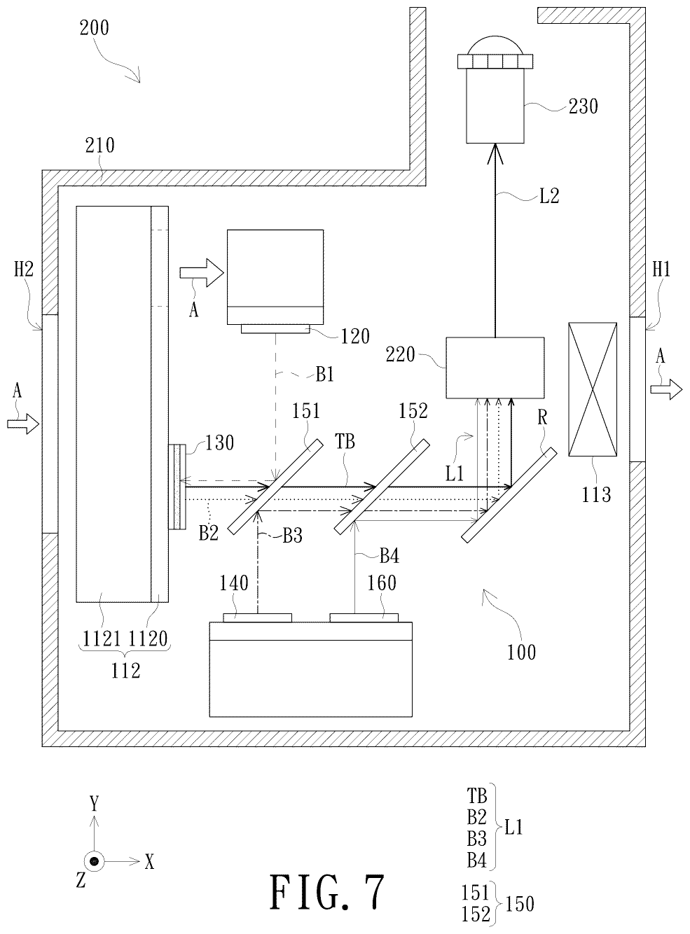

FIG. 1 is a schematic view of a light source module of an embodiment of the disclosure. FIG. 2 is a stereoscopic schematic view of the first heat dissipation component and the second heat dissipation component in FIG. 1. Please refer to FIG. 1 and FIG. 2 together. The light source module 100 is applicable to a projection device 200 (shown in FIG. 7), and the detailed features of the projection device 200 will be described in the subsequent paragraphs. The light source module 100 includes a heat dissipation assembly 110, a first light source 120 and a second light source 130. The heat dissipation assembly 110 includes a first heat dissipation component 111 and a second heat dissipation component 112, and may further include a fan 113 (shown in FIG. 1). The first heat dissipation component 111 includes a first base 1110 and a first fin set 1111 connected to each other. The first fin set 1111 has a first ventilation surface AS1 (shown in FIG. 1). The second heat dissipation component 112 includes a second base 1120 and a second fin set 1121. The second base 1120 has a first surface S1, a second surface S2 and a ventilation opening O. The first surface S1 is opposed to the second surface S2. The second fin set 1121 is arranged on the first surface S1. The second surface S2 faces the first ventilation surface AS1. The ventilation opening O penetrates the first surface S1 and the second surface S2 and is aligned with the first ventilation surface AS1. The fan 113 is configured to generate airflow A flowing through the second fin set 1121, the ventilation opening O and the first ventilation surface AS1. The first light source 120 is arranged on the first base 1110. The second light source 130 is arranged on the second base 1120.

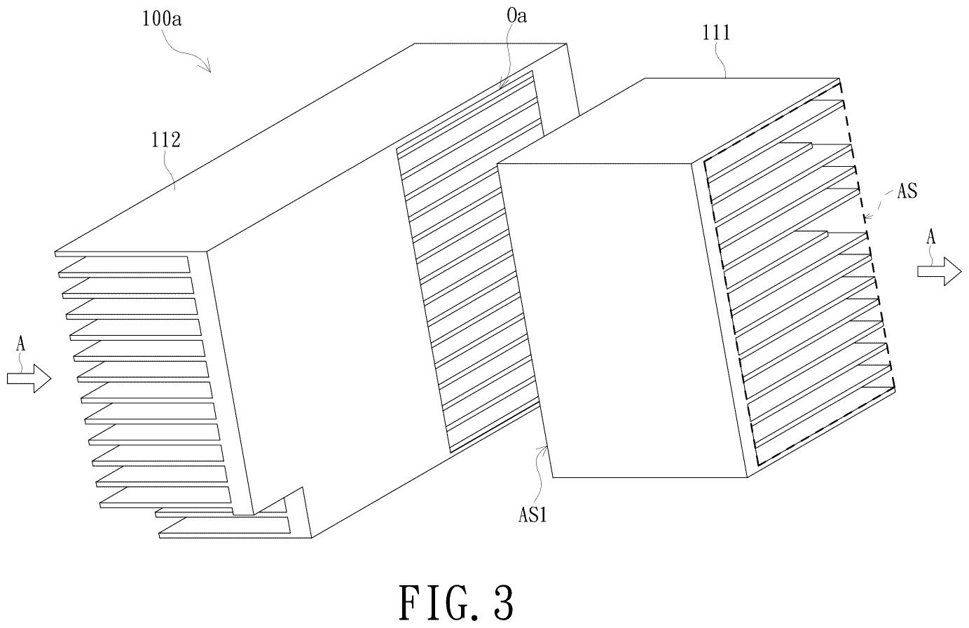

The heat dissipation assembly 110 is configured to reduce the temperature of the first light source 120 and the second light source 130. The heat dissipation assembly 110 is a heat-pipe-free structure in this embodiment. That is, the first heat dissipation component 111 and the second heat dissipation component 112 are, for example, heat-pipe-free heat dissipation components, which can reduce the volume size and cost of the heat dissipation assembly 110. The ventilation opening O of the second heat dissipation component 112 of this embodiment can be formed on the second base 1120 by computer numerical control (CNC) machining. It is understood that the opening area of the ventilation opening O can be set according to actual needs. For example, the opening area of the ventilation opening O may be slightly smaller than the area of the first ventilation surface AS1, as shown in FIG. 2. However, in one embodiment of the light source module 100a as shown in FIG. 3, the opening area of the ventilation opening Oa is, for example, equal to the area of the first ventilation surface AS1, wherein the area of the ventilation surface AS in FIG. 3 is equal to the area of the first ventilation surface AS1. In this way, the ventilation opening Oa allows more airflow A to pass through the first ventilation surface AS1, thereby improving the heat dissipation efficiency of the first heat dissipation component 111.

Refer to FIGS. 1 and 2 again. The second fin set 1121 of this embodiment may extend on the first surface S1 and partially overlap the ventilation opening O. For example, the second fin set 1121 may overlap the entire ventilation opening O as shown in FIG. 2. The first fin set 1111 includes, for example, a plurality of first fins F1. The first fins F1 are arranged at intervals along the first direction D1. The second fin set 1121 includes, for example, a plurality of second fins F2. The second fins F2 are arranged at intervals along the second direction D2. The first direction D1 is identical to the second direction D2, wherein the first direction D1 and the second direction D2 are identical to the Z direction in FIG. 1. In short, the first fins F1 and the second fins F2 each are arranged at intervals in the same direction, which reduces the turbulence generated when the airflow A flows through the first fins F1 and the second fins F2, so as to increase the airflow flowing through the first fins F1 and the second fins F2 and therefore improving the heat dissipation efficiency. The airflow A may pass between the second fins F2 of the second fin set 1121 and is transmitted to the first ventilation surface AS1 of the first heat dissipation component 111.

Please refer to FIG. 1 again. The fan 113 is, for example, an axial fan, and the first fin set 1111 is arranged between the second heat dissipation component 112 and the fan 113. In this embodiment, the airflow A generated by the fan 113 may flow between the second fins F2 of the second fin set 1121 and pass through the ventilation opening O of the second base 1120 to cool the second light source 130 arranged on the second heat dissipation component 112. Further, because the ventilation opening O and the first ventilation surface AS1 of the first fin set 1111 are in alignment with each other, the airflow A can also enter the first fin set 1111 from the ventilation opening O and pass between the first fins F1 of the first fin set 1111 to cool the first light source 120 arranged on the first heat dissipation component 111. It should be noted that the second base 1120 of the second heat dissipation component 112 will not be provided with the ventilation opening O in the design of the prior-art technical architecture; thus, because the ventilation direction of the first heat dissipation component 111 and that of the second heat dissipation component 112 are different from each other and the airflow A generated by the fan 113 is a single flow field, the airflow A cannot effectively cool the first heat dissipation component 111 and the second heat dissipation component 112 at the same time. In contract, because the second base 1120 has a ventilation opening O aligned with the first ventilation surface AS1 in an embodiment of the disclosure, the airflow A with a single flow field can pass through the first heat dissipation component 111 and the second heat dissipation component 112, thereby improving the heat dissipation efficiency and also making the position of the fan 113 easier to configure. Further, in the embodiment of the disclosure, it is not necessary to provide a heat pipe as a heat dissipation element between the first heat dissipation component 111 and the first fin set 1111 as well as the second heat dissipation component 112 and the second fin set 1121 by heat conduction. Thus, without the heat pipe, the volume of the entire light source module 100 is reduced. In addition, the position of the fan 113 of this embodiment is not limited to FIG. 1.

The first light source 120 and the second light source 130 have different light-emitting wavelengths and colors. For example, the first light source 120 is configured to generate a first beam B1, and the second light source 130 is configured to generate a second beam B2, wherein the wavelength of the first beam B1 and the wavelength of the second beam B2 are different from each other. The detailed features of the first beam B1 and the second beam B2 will be described in the subsequent paragraphs. Similarly, the detailed features of the first light source 120 and the second light source 130 are also described in the subsequent paragraphs.

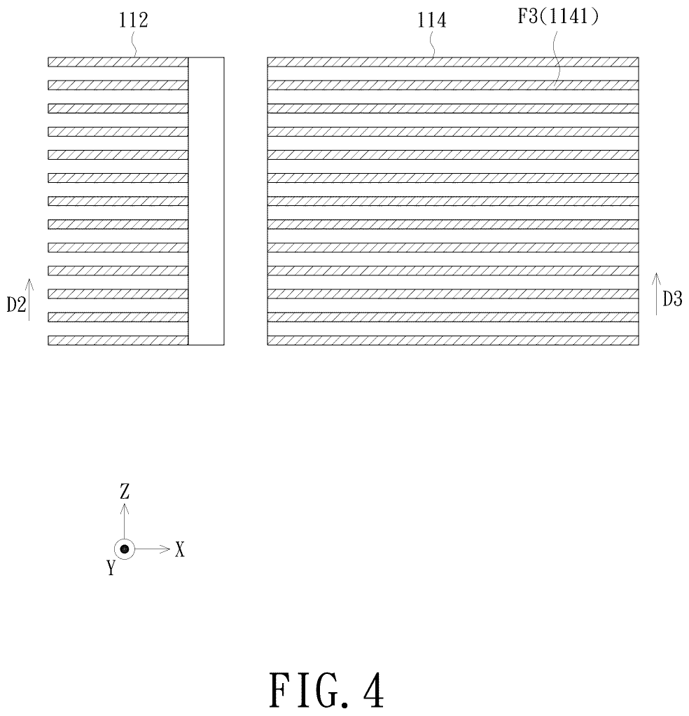

Further, the light source module 100 of this embodiment may further include a third light source 140. The heat dissipation assembly 110 further includes, for example, a third heat dissipation component 114, and the third heat dissipation component 114 is opposite to the first heat dissipation component 111. The third heat dissipation component 114 includes a third base 1140 and a third fin set 1141. The third base 1140 has a third surface S3 and a fourth surface S4 opposite to each other. The third fin set 1141 is arranged on the third surface S3. The fourth surface S4 faces the surface S of the first base 1110 arranged the first light source 120. The third light source 140 is arranged on the fourth surface S4. In detail, the third light source 140 is configured to generate a third beam B3, wherein the wavelength of the third beam B3 is different from that of the second beam B2. The detailed features of the third beam B3 will be described in subsequent paragraphs. In this embodiment, the third heat dissipation component 114 may be a heat-pipe-free dissipation component to further reduce the volume and cost of the heat dissipation assembly 110. Please refer to FIGS. 1 and 4 together, wherein FIGS. 1 and 4 show the relationship of viewing angles in X, Y, and Z directions. The third fin set 1141 may include a plurality of third fins F3. The third fins F3 are arranged at intervals along a third direction D3, wherein the third direction D3 is, for example, identical to the Z direction in FIG. 1. The first direction D1, the second direction D2 and the third direction D3 are identical to each other. In short, the first fins F1, the second fins F2, and the third fins F3 may be arranged at intervals along the same direction, which can reduce the turbulence generated when the airflow A flows through the first fins F1, the second fins F2 and the third fins F3, so as to further increase the airflow flowing through the first fins F1, the second fins F2 and the third fins F3 and therefore further improving the heat dissipation efficiency of the light source module 100.

Please continue to refer to FIG. 1. The light source module 100 further includes, for example, a light guide assembly 150. The second light source 130 may include a wavelength conversion layer W and a blue light source. The wavelength conversion layer W is configured to convert the first beam B1 into a converted beam TB and convert the blue light generated by the blue light source into the second beam B2. The converted beam TB and the second beam B2 are both green beams. The light guide assembly 150 includes a first dichroic component 151. The first dichroic component 151 is arranged on the transmission path of the first beam B1, the second beam B2, and the converted beam TB. The first dichroic component 151 is configured to allow the second beam B2 and the converted beam TB to pass therethrough and reflect the first beam B1 to the wavelength conversion layer W. In detail, the second light source 130 has more thermal energy than the first light source 120 due to that the second light source 130 is irradiated by the first beam B1, and therefore, the volume size of the second heat dissipation component 112 is greater than that of the first heat dissipation component 111. In this embodiment, the first beam B1 may be a blue beam (e.g., a blue laser beam) and is converted into a green beam (i.e., the converted beam TB) by the wavelength conversion layer W after incident to the wavelength conversion layer W. The second beam B2 is also a green beam transmitted from the second light source 130 to the light guide assembly 150. Further, the first dichroic component 151 may reflect the blue beam and allow the green beam to pass therethrough. In this embodiment, the first dichroic component 151 and the second dichroic component 152 are, for example, dichroic mirrors.

Further, the light source module 100 of this embodiment further includes, for example, a fourth light source 160. The fourth light source 160 is arranged on the fourth surface S4. The fourth light source 160 is configured to generate a fourth beam B4. The first dichroic component 151 is further arranged on the transmission path of the third beam B3. The light guide assembly 150 may further include a second dichroic component 152. The second dichroic component 152 is arranged on the transmission path of the converted beam TB, the second beam B2, the third beam B3 and the fourth beam B4. The first dichroic component 151 is configured to reflect the third beam B3 to the second dichroic component 152 and reflect the first beam B1 to the wavelength conversion layer W. The second dichroic component 152 is configured to allow the converted beam TB, the second beam B2, and the third beam B3 to pass therethrough and reflect the fourth beam B4. Thus, the first beam B1, the converted beam TB, the second beam B2, the third beam B3 and the fourth beam B4 can be emitted from the light guide assembly 150. The fourth beam B4 of this embodiment is, for example, a red beam. The second dichroic component 152 may reflect the red beam and allow the blue beam (i.e., the third beam B3) and the green beam (i.e., the converted beam TB and the second beam B2) to pass therethrough, so that the aforementioned red beam, blue beam and green beam can exit from the light guide assembly 150. Similarly, the second dichroic component 152 may be a dichroic mirror, but the disclosure is not limited thereto. Other detailed features of the fourth light source 160 of this embodiment are described in subsequent paragraphs.

Compared with the prior art, in the light source module 100 of this embodiment, the second heat dissipation component 112 adopts a second base 1120 having a ventilation opening O, and the ventilation opening O is aligned with the first ventilation surface AS1 of the first fin set 1111. Thus, the airflow A generated by the fan 113 can flow through the first fin set 1111 through the ventilation opening O. Based on the above, the light source module 100 of this embodiment can improve the heat dissipation efficiency without changing the existing conditions such as the optical path design and the flow field of the fan 113.

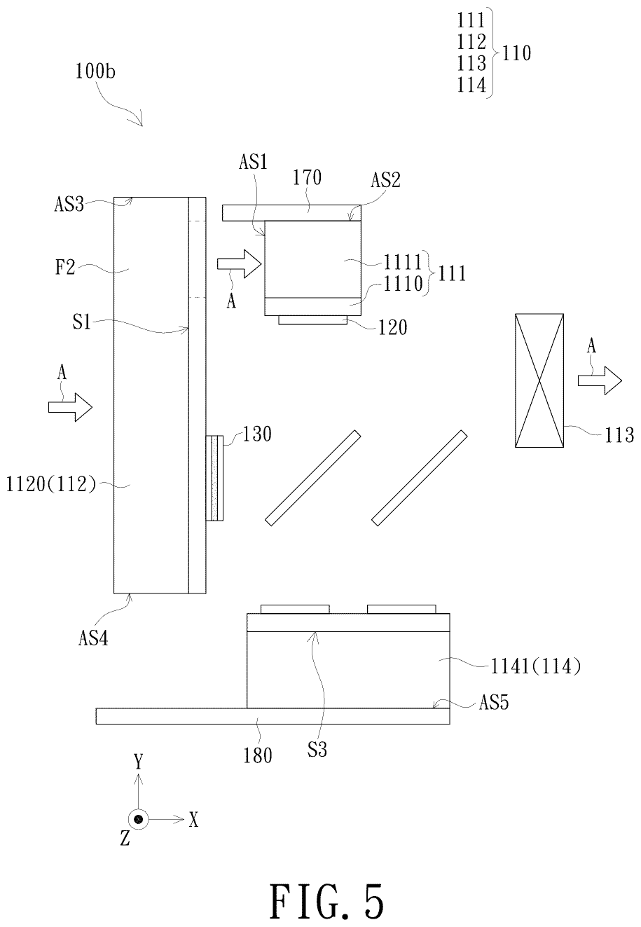

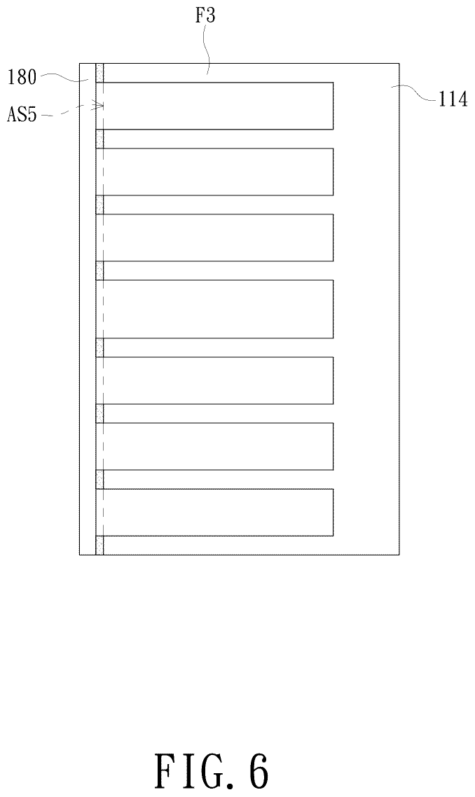

FIG. 5 is a schematic view of a light source module of another embodiment of the disclosure. FIG. 6 is a schematic view of the third heat dissipation component and the second deflector in FIG. 5. The structure and advantages of the light source module 100b of this embodiment are similar to those in the embodiment of FIG. 1, and only the differences are explained below. Please refer to FIG. 5 first. The light source module 100b further includes, for example, a first deflector 170 and a second deflector 180. In the heat dissipation assembly 110 of this embodiment, the first fin set 1111 of the first heat dissipation component 111 further includes a second ventilation surface AS2. The second ventilation surface AS2 is adjacent to the first ventilation surface AS1 and opposite to the first base 1110. The second fin set 1120 of the second heat dissipation component 112 further includes a third ventilation surface AS3 and a fourth ventilation surface AS4 opposite to each other. The third ventilation surface AS3 and the fourth ventilation surface AS4 are adjacent to the first surface S1, and the third ventilation surface AS3 is closer to the first heat dissipation component 111 than the fourth ventilation surface AS4. The third heat dissipation component 114 is close to the fourth ventilation surface AS4. The third fin set 1141 further includes a fifth ventilation surface AS5, and the fifth ventilation surface AS5 faces away from the third surface S3. The third fin set 1141 is arranged between the fifth ventilation surface AS5 and the third surface S3. The first deflector 170 is arranged on the second ventilation surface AS2. The second deflector 180 is arranged opposite to the fifth ventilation surface AS5. In detail, the first deflector 170 can prevent the airflow A from flowing out of the first fin set 1111 through the second ventilation surface AS2. Similarly, the second deflector 180 can prevent the airflow A from flowing out of the third fin set 1141 through the fifth ventilation surface AS5. Thus, the first deflector 170 and the second deflector 180 can increase the airflow passing through the first fin set 1111 and the third fin set 1141, thereby improving the heat dissipation efficiency. The first deflector 170 and the second deflector 180 contact the first fin set 1111 and the third fin set 1141, respectively.

Further, the first deflector 170 may cover the second ventilation surface AS2 to further reduce the airflow flowing from the second ventilation surface AS2. Similarly, the second deflector 180 may cover the fifth ventilation surface AS5 to further reduce the airflow flowing from the fifth ventilation surface AS5. Referring to the third heat dissipation assembly 114 of FIG. 6, the second deflector 180 for example fixes to and touches the side of the third fins F3 and covers the fifth ventilation surface AS5. Specifically, the second deflector 180 of this embodiment may be glued and fixed to the side of the third fins F3, but the disclosure does not limit the fixing method. Similarly, in the embodiment of FIG. 5, the first deflector 170 may be fixed to the side of the second fins F2 in a manner similar to FIG. 6 and cover the second ventilation surface AS2. In addition, it can be understood that the area sizes of the first deflector 170 and the second deflector 180 may be changed according to the area sizes of the first fin set 1111 and the third fin set 1141, and the disclosure is not limited thereto. In this embodiment, the material of the first deflector 170 and the second deflector 180 may include mylar, but other embodiments are not limited thereto.

FIG. 7 is a schematic view of a projection device of an embodiment of the disclosure. Referring to FIG. 7, the projection device 200 includes a housing 210, a light source module 100, a light valve module 220, and a projection lens 230. The light source module 100, the light valve module 220, and the projection lens 230 are arranged in the housing 210. The housing 210 has a ventilation hole H1. The light source module 100 is configured to provide an illumination beam L1. The light valve module 220 is arranged on the transmission path of the illumination beam L1 and configured to convert the illumination beam L1 into an image beam L2. The projection lens 230 is arranged on the transmission path of the image beam L2 and configured to project the image beam L2. It should be noted that the light source module 100 in FIG. 7 may be replaced with the aforementioned light source module 100a or 100b in other embodiments.

The housing 210 of this embodiment may further have a ventilation hole H2, and the ventilation holes H1 and H2 are communicated with each other. Specifically, the airflow A generated by the fan 113 may flow into the housing 210 through the ventilation hole H2 (e.g., an air inlet) and exit the housing 210 from the ventilation hole H1 (e.g., an air outlet). It is understood that the shape of the housing 210 shown in FIG. 7 is illustrative only and is not intended to limit the disclosure.

As previously described, in the light source module 100 of this embodiment, the first dichroic component 151 of the light guide assembly 150 may reflect the first beam B1 and the third beam B3 generated by the third light source 140 and allow the converted beam TB to pass therethrough. Further, the second dichroic component 152 of the light guide assembly 150 may reflect the fourth beam B4 generated by the fourth light source 160 and allow the second beam B2, the third beam B3 and the converted beam TB to pass therethrough. Thus, the illumination beam L1 of this embodiment includes at least one of the second beam B2, the third beam B3, the fourth beam B4 and the converted beam TB. After the illumination beam L1 is emitted from the light guide assembly 150, the illumination beam L1 may be reflected to the light valve module 220 by the reflective element R. In this embodiment, the first beam B1 is a blue laser beam, the second beam B2 is a green beam, the third beam B3 is a blue beam, the fourth beam B4 is a red beam, and the converted beam TB is a green beam.

Incidentally, the first light source 120, the second light source 130, the third light source 140 and the fourth light source 160 in this embodiment may be light-emitting diodes or laser diodes. Further, the number of light-emitting diodes or laser diodes may be one or more. For example, the light-emitting diodes (or laser diodes) may be arranged into a matrix when the number of light-emitting diodes (or laser diodes) is plural.

The light valve module 220 of this embodiment includes, for example, a digital micromirror device (DMD), but other embodiments are not limited thereto. For example, the optical valve module 220 in one embodiment may include a liquid crystal on silicon (LCoS) or a liquid crystal display (LCD). Further, the disclosure does not limit the number of light valve modules 220. For example, the projection device 200 in one embodiment can adopt a single-chip liquid crystal display panel or three-chip liquid crystal display panel structure, but the disclosure is not limited thereto. Taking a light valve module 220 as an example, the light valve module 220 may further include a fourth heat dissipation fin set, and the fourth heat dissipation fin set has a plurality of fourth heat dissipation fins. The fourth heat dissipation fins are arranged at intervals along the Y direction. The airflow A may flow through the interval between the fourth heat dissipation fins.

The projection lens 230 includes, for example, one or more optical lenses, and the diopters of the optical lenses may be the same or different from each other. For example, the aforementioned optical lenses may include a biconcave lens, a biconvex lens, a concave-convex lens, a convex-concave lens, a plano-convex lens, and a plano-concave lens, or any combination of the above non-planar lenses. On the other hand, the projection lens 230 may also include a flat optical lens. The disclosure does not limit the specific structure of the projection lens 230.

Compared with the prior art, by adopting the light source module 100, the projection device 200 of this embodiment can have good image quality, improved durability, and low cost.

In summary, in the light source module of the embodiment, the second heat dissipation component adopts a second base having a ventilation opening, and the ventilation opening is aligned with the first ventilation surface of the first fin set. Therefore, the airflow generated by the fan can still flow through the first heat dissipation component and the second heat dissipation component through the ventilation opening even when the first heat dissipation component and the second heat dissipation component cannot be configured in the same ventilation direction. Based on the above, the light source module of the disclosure can improve the heat dissipation efficiency without changing the existing conditions such as the optical path design and the fan flow field. By adopting the light source module, the projection device of the embodiment can have good image quality and durability and also has the advantage of low cost.

The foregoing description of the preferred embodiment has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode of practical application, thereby enabling persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the invention” or the like is not necessarily limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments. It should be appreciated that variations may be made in the embodiments described by persons skilled in the art without departing from the scope of the disclosure as defined by the following claims. Moreover, no element or component in the disclosure is intended to be dedicated to the public regardless of whether the element or component is explicitly recited in the following claims. Furthermore, the terms such as the first heat dissipation component, the second heat dissipation component, the first base, the second base, the first fin set, the second fin set, the first surface, the second surface, the first direction, the second direction, the first deflector, the second deflector, the first dichroic component, the second dichroic component, the first light source and the second light source are only used for distinguishing various elements and do not limit the number of the elements.

What is claimed is:

1. A light source module applicable to a projection device, the light source module comprising:
a heat dissipation assembly, comprising:
a first heat dissipation component, comprising a first base and a first fin set connected with each other, wherein the first fin set has a first ventilation surface; and
a second heat dissipation component, comprising a second base and a second fin set, wherein the second base has a first surface, a second surface and a ventilation opening, the first surface is opposite to the second surface, the second fin set is arranged on the first surface, the second surface faces the first ventilation surface, and the ventilation opening penetrates the first surface and the second surface and is aligned with the first ventilation surface;
a first light source, arranged on the first base; and
a second light source, arranged on the second base.

2. The light source module according to claim 1, wherein an opening area of the ventilation opening is greater than or equal to an area of the first ventilation surface.

3. The light source module according to claim 1, wherein the second fin set extends on the first surface and partially overlaps the ventilation opening.

4. The light source module according to claim 1, wherein the first fin set comprises a plurality of first fins, the first fins are arranged at intervals along a first direction, the second fin set comprises a plurality of second fins, the second fins are arranged at intervals along a second direction, and the first direction is identical to the second direction.

5. The light source module according to claim 1, further comprising a third light source, wherein the heat dissipation assembly further comprises a third heat dissipation component, the third heat dissipation component is opposite to the first heat dissipation component, the third heat dissipation component comprises a third base and a third fin set, the third base has a third surface and a fourth surface opposite to each other, the third fin set is arranged on the third surface, the fourth surface faces a surface of the first base arranged the first light source, and the third light source is arranged on the fourth surface.

6. The light source module according to claim 5, wherein:
the first fin set comprises a plurality of first fins, arranged at intervals along a first direction;
the second fin set comprises a plurality of second fins, arranged at intervals along a second direction;
the third fin set comprises a plurality of third fins, arranged at intervals along a third direction;
the first direction, the second direction and the third direction are identical to each other.

7. The light source module according to claim 5, further comprising a first deflector and a second deflector, wherein:
the first fin set further comprises a second ventilation surface, adjacent to the first ventilation surface and opposite to the first base;
the third heat dissipation component is close to the fourth ventilation surface, and the third fin set further comprises a fifth ventilation surface facing away from the third surface;
the first deflector is arranged opposite to the second ventilation surface, and the second deflector is arranged opposite to the fifth ventilation surface.

8. The light source module according to claim 7, wherein the first deflector covers the second ventilation surface, and the second deflector covers the fifth ventilation surface.

9. The light source module according to claim 5, further comprising a light guide assembly, wherein the first light source is configured to generate a first beam, the second light source has a wavelength conversion layer, the wavelength conversion layer is configured to convert the first beam into a converted beam, the light guide assembly comprises a first dichroic component arranged on a transmission path of the first beam and the converted beam, and the first dichroic component is configured to allow the converted beam to pass therethrough and reflect the first beam to the wavelength conversion layer.

10. The light source module according to claim 9, further comprising a fourth light source arranged on the fourth surface, wherein the third light source is configured to generate a third beam, the fourth light source is configured to generate a fourth beam, and the first dichroic component is further arranged on a transmission path of the third beam, wherein:
the light guide assembly further comprises a second dichroic component, arranged on a transmission path of the converted beam, the third beam and the fourth beam;
the first dichroic component is further configured to reflect the third beam to the second dichroic component, and the second dichroic component is configured to allow the converted beam and the third beam to pass therethrough and reflect the fourth beam.

11. The light source module according to claim 1, further comprising a fan, configured to generate an airflow passing through the ventilation opening and the first ventilation surface.

12. A projection device, comprising a housing, a light source module, a light valve module, and a projection lens, wherein the light source module, the light valve module, and the projection lens are arranged in the housing, the housing has a ventilation hole, the light source module is configured to provide an illumination beam, the light valve module is arranged on a transmission path of the illumination beam and configured to convert the illumination beam into an image beam, the projection lens is arranged on a transmission path of the image beam and configured to project the image beam, and the light source module comprises:
a heat dissipation assembly, comprising:
a first heat dissipation component, comprising a first base and a first fin set connected with each other, wherein the first fin set has a first ventilation surface; and
a second heat dissipation component, comprising a second base and a second fin set, wherein the second base has a first surface, a second surface, and a ventilation opening, the first surface is opposite to the second surface, the second fin set is arranged on the first surface, the second surface faces the first ventilation surface, and the ventilation opening penetrates the first surface and the second surface and is aligned with the first ventilation surface;
a first light source, arranged on the first base; and
a second light source, arranged on the second base.

13. The projection device according to claim 12, wherein the light source module further comprises a third light source, the heat dissipation assembly further comprises a third heat dissipation component, the third heat dissipation component is opposite to the first heat dissipation component, the third heat dissipation component comprises a third base and a third fin set, the third base has a third surface and a fourth surface opposite to each other, the third fin set is arranged on the third surface, the fourth surface faces a surface of the first base arranged the first light source, and the third light source is arranged on the fourth surface.

14. The projection device according to claim 13, wherein the light source module further comprises a light guide assembly, the first light source is configured to generate a first beam, the second light source has a wavelength conversion layer, the wavelength conversion layer is configured to convert the first beam into a converted beam, the light guide assembly comprises a first dichroic component arranged on a transmission path of the first beam and the converted beam, and the first dichroic component is configured to allow the converted beam to pass therethrough and reflect the first beam to the wavelength conversion layer.

15. The projection device according to claim 14, wherein the light source module further comprises a fourth light source arranged on the fourth surface, the third light source is configured to generate a third beam, the fourth light source is configured to generate a fourth beam, and the first dichroic component is further arranged on a transmission path of the third beam, wherein:
the light guide assembly further comprises a second dichroic component, arranged on a transmission path of the converted beam, the third beam, and the fourth beam;
the first dichroic component is further configured to reflect the third beam to the second dichroic component, the second dichroic component is configured to allow the converted beam and the third beam to pass therethrough and reflect the fourth beam, and the illumination beam comprises at least one of the converted beam, the third beam, and the fourth beam.
